(19) United States
(12) Patent Application Publication
(10) Pub. No.: US 2021/0147764 A1
(43) Pub. Date: May 20, 2021

(54) CLEANING COMPOSITION

(71) Applicant: WOW KEMICAL S.R.L., Vigonza (PD) (IT)

(72) Inventor: Adriano Marin, Baone (PD) (IT)

(21) Appl. No.: 17/045,306

(22) PCT Filed: Apr. 10, 2019
(86) PCT No.: PCT/IB2019/052953

§ 371 Date: Oct. 5, 2020

(30) Foreign Application Priority Data
Apr. 13, 2018 (IT) 102018000004475

(51) Int. Cl. C11D 3/20; C11D 3/43; C11D 3/18; C11D 1/66; C11D 1/22; C11D 1/29; C11D 1/88

(52) U.S. Cl. CPC C11D 3/2086; C11D 3/2082; C11D 3/43; C11D 1/886; C11D 1/662; C11D 1/22; C11D 1/29; C11D 3/188

(57) ABSTRACT

The present invention relates to a cleaning composition and to a cleaning method in the industrial or household field comprising the use of said composition.

The present invention relates to a cleaning composition and to a cleaning method in the industrial or household field comprising the use of said composition.

Chemical detergents commonly used in industrial processes and in the household field constitute one of the main causes of environmental pollution, especially in relation to water courses, seas, water tables and water reserves for human use.

Surfactants deriving from the refinement of crude oil, such as SLES (sodium lauryl ether sulfate) and SLS (sodium lauryl sulfate) foaming agents, have a high impact on the environment both during the extraction and release steps.

These surfactants, as well as not being biodegradable, once they reach the rivers and seas through the drains, are also responsible, amongst other things (together with residues from fertilizers used in agriculture) for the phenomenon of the eutrophication of water and are not at all biodegradable.

In fact, the most commonly used detergents are made with large quantities of substances deriving from sulfur, phosphorus and nitrogen, which constitute nutrients for aquatic plants and can make them proliferate excessively. Microalgae are also, therefore, over-nourished and produced in quantities such as not to be able to be digested by the primary consumers (i.e. aquatic animals). The excess of aquatic vegetation can increase bacterial activity, reduce the quantity of oxygen in the water and, in fact, “suffocate” the aquatic organisms.

Another important problem connected with large-scale production of surfactants, and of other components of synthetic origin of detergents for industrial and household use, is the industrial waste generated during the production of products of the petrochemical industry which, in turn, can end up in the fields, penetrate as far as the water table, pollute yet again rivers and seas and create problems for flora and fauna, particularly in marine and coastal areas.

The production of detergents containing derivatives of crude oil has not dropped significantly in recent decades despite the increased sensitivity in general towards environmental issues. Furthermore, the so-called natural based detergents currently available are often more expensive and can have lower performance levels in terms of cleaning with respect to analogs of synthetic origin.

The need is therefore felt to have available detergents for household or industrial use that are efficient, cheap, eco-sustainable and with minimal environmental impact.

An object of the present invention is to provide a composition for use as detergents that do not have the disadvantages reported above.

The subject matter of the present invention is a method for cleaning a substrate in the industrial or in the household field, wherein said method comprises at least applying to the part of said substrate to be cleaned an aqueous composition (C) comprising:

i. at least one organic acid selected from citric acid, oxalic acid, tartaric acid, malic acid, the respective sodium or potassium salts, and mixtures thereof;

ii. at least one solvent selected from methanol, ethanol, propanol and isomers thereof, preferably propylene glycol, butanol and isomers thereof, a water soluble low molecular weight ester, preferably methyl acetate, ethyl acetate, ethyl formate, dimethyl carbonate, esters of carbonic acid, and mixtures thereof, and

iii. at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin, and relative mixtures, so as to obtain an aqueous mixture comprising the components of (C) and the residues of the contaminant.

The subject matter of the present invention is a cleaning composition (C) in liquid form comprising at least water and:

i. at least one selected from citric acid, oxalic acid, tartaric acid, malic acid, the respective sodium or potassium salts, and mixtures thereof and a mixture thereof in amount from 0.4 to 45% by weight of the total volume of the composition,

ii. at least one solvent selected from methanol, ethanol, propanol and isomers thereof, preferably propylene glycol, butanol and isomers thereof, a water soluble low molecular weight ester, preferably methyl acetate, ethyl acetate, ethyl formate, dimethyl carbonate, esters of carbonic acid, and mixtures thereof, in an amount from 1.5 to 20% by weight of the total volume of the composition, and

iii. at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin, and relative mixtures in an amount from 0.1 to 7% by weight with respect to the total volume of the composition.

Unless otherwise indicated, within the context of the present invention the percentages and quantities of a component in a mixture relate to the weight of such component with respect to the total volume of the mixture, e.g. 10% indicates 100 g in a litre of composition.

Unless otherwise specified, within the context of the present invention the indication that a composition “comprises” one or more components or substances means that other components or substances may be present in addition to the one, or ones, specifically indicated.

Unless otherwise specified, within the context of the present invention a range of values indicated for a magnitude, e.g. the content by weight of a component, includes the lower limit and the upper limit of the range. For example, if the content by weight or by volume of a component A is indicated as “from X to Y”, where X and Y are numerical values, A may be X or Y or any one of the intermediate values.

The inventor has surprisingly found that it is possible to clean matrices and surfaces of various kinds efficiently and quickly through the application of the composition as defined above, which is able to remove contaminants such as grease, dust and dirt in general, without any particular limitations.

The method of the present invention is particularly suitable for the total or partial removal of contaminants consisting of, or comprising, fats of plant, animal or mineral origin (deriving from crude oil). However, the method of the present invention can also be applied, with excellent results in terms of efficiency and speed, to the removal of contaminants other than fats, such as dyes, non-fatty substances of natural origin and the like, from solid surfaces and also from garments, textiles, tableware, glassware, cutlery and the like, without any particular limitations.

Advantageously, the composition (C) as defined above allows said removal to be obtained with high efficiency and minimal environmental impact, as it contains highly biodegradable components that are considered to be low pollutants.

In a preferred embodiment, in the method according to the present invention the aqueous composition (C) comprises the organic acid i. in an amount from 0.4 to 45%, preferably from 5 to 20%, more preferably from 11 to 18% by weight with respect to the total volume of the composition (C).

Within the context of the present invention, an isomer of propanol and butanol means at least one alcohol from between n-propanol (1-propanol), iso-propanol (or 2-propanol), n-butanol (or 1-butanol), sec-butanol (or 2-butanol), iso-butanol (2-methyl-1-propanol), propylene glycol, dimethyl carbonate, esters of carbonic acid and ter-butanol (2-methyl-2-propanol).

In a preferred embodiment, in the method of the present invention the solvent ii. is ethyl acetate, or ethanol, more preferably ethyl acetate, or a mixture of C₁-C₄ alcohols as defined above comprising at least ethanol.

In a preferred embodiment, in the method of the present invention the solvent ii. is dimethyl carbonate, or a mixture comprising at least dimethyl carbonate.

In a preferred embodiment, in the method according to the present invention the aqueous composition (C) comprises the solvent ii. in an amount from 1.5 to 20%, preferably from 3.5 to 18%, more preferably from 4 to 15% by weight with respect to the total volume of the composition (C).

Within the context of the present invention, coco-glucoside means a non-ionic surfactant generally considered to be safe (GRAS). From the point of view of the chemical structure, it is an ether between C₈-C₁₆ fatty alcohols and glucose oligomers (CAS number 141464-42-8). In water it forms a viscous, turbid solution and can be used to obtain the composition (C) according to the invention also as an aqueous solution in which the percentage of active ingredient is generally comprised between 50 and 60%. It has excellent foaming properties and is advantageously biodegradable in a relatively short time and without leaving residues, according to the criteria of EC regulation No. 648/2004 on detergents.

In a preferred embodiment, the surfactant iii. in the composition (C) of the method according to the present invention is coco-glucoside, possibly with the stabilizer glyceryl oleate added.

In a preferred embodiment, in the method according to the present invention, the aqueous composition (C) comprises the surfactant iii. in an amount from 0.1 to 7%, preferably from 1.5 to 6%, more preferably from 2 to 5% by weight with respect to the total volume of the composition (C).

In a preferred embodiment, but without limitations, the three components i., ii. and iii. are in a weight ratio to each other from 12:2:2 to 20:5:6.

In a preferred embodiment, in the composition (C) of the method according to the present invention the acid i. is citric acid, the solvent ii. is ethyl acetate or ethanol and the surfactant iii. is coco-glucoside.

In a preferred embodiment, the composition (C) of the method according to the present invention comprises at least one emulsifier from between soy lecithin, soy lysolecithin and mixtures thereof and, furthermore, limonene or another terpene analog, preferably of natural origin.

Within the context of the present invention, “soy lecithin” means a phosphatidylcholine, i.e. a phosphoglyceride in which phosphatidic acid is esterified with choline, which can be obtained, without limitation, from soybeans or from their oil.

Within the context of the present invention “lysolecithin”, also known as hydrolysed lecithin or isocitin, (CAS Number 85711-58-6), means a derivative of lecithin in which at least one fatty acid radical has been removed enzymatically at least in a part or in all of the phospholipids.

Within the context of the present invention, the definition “terpene analog of limonene”, includes, without limitations, compounds of natural original, terpenoids or having a monoterpene, diterpene, sesquiterpene structure, which are derivatives, precursors, diastereoisomers, optical isomers of limonene or that comprise in the chemical formula the structure of limonene. Non-limiting examples of said terpenes are cyclic terpene compounds such as terpinene, terpineol, camphor, borneol, menthol, carvone, eucalyptol, bisabolene, bergamotene, carene, carane, pinene, thujene, sabinene, germacrene, valencene, caryophyllene, tujone, natural oils and extracts such as lemon oil, absinthe oil and derivatives thereof, linear terpinene compounds such as: geraniol, citral, myrcene, nerol, neral, citronellol, citronellal, linalool, linalyl acetate, ocimene, farnesol and derivatives thereof, aromatic terpene compounds such as: eugenol, anethole, thymol, safrole, chavicol derivatives thereof and their isomers, and mixtures thereof. The composition (C) according to the present invention may contain terpenes, or analogs thereof, in the form of mixtures such as natural citrus extracts or of other plants or matrices of organic origin.

The limonene in the composition (C) of the present invention may be, without limitations, racemic limonene (CAS number 138-86-3) or D-limonene (CAS Number 5989-54-8) or any scalemic mixture of the two limonene enantiomers. Also the other terpenes, possibly present, may be, without limitations, in enantiomerically pure, scalemic or racemic form.

In a preferred embodiment, in the method of the present invention the limonene terpene analog is at least one from among citral, geraniol, menthol, eucalyptol, lemon oil and citronellol.

Preferably, in the composition (C) of the method according to the present invention limonene, or a terpene analog, where present, is contained in an amount from 0.1 to 7.5%, more preferably from 0.3 to 5%, even more preferably from 0.5 to 2.5%, by weight with respect to the total volume of the composition (C), and/or the emulsifier is contained in an amount from 0.1 to 1% by weight with respect to the total volume of the composition (C).

The composition (C) in the method according to the present invention may be in the liquid or semi-liquid form e.g. without limitations, in the form of an aqueous solution, suspension, gel, cream, paste and the like.

The composition (C) in the method according to the present invention may be applied to the surface to be decontaminated through any method known to a person skilled in the art, e.g. with high or low pressure systems, by spraying, sprinkling, through brushes or other tools, or the substrate to be cleaned can be immersed in the composition or it can be impregnated with it, according to the size and nature of the substrate. As a convenient application, the liquid can be applied in an electrolytic cell or with an electropolisher pad/gripper pre-selected with alternating output voltage.

As a non-limiting example, the substrate to be cleaned/decontaminated with the method according to the present invention may comprise, or consist of, metal or plastic surfaces of various kinds, enamels, paints, cement and various composites. In the case of a non-electrically conducting substrate, the electropolisher pad/gripper will be provided with 2 electrodes with opposite polarity from each other.

Furthermore, the substrate to be cleaned with the method according to the present invention may be an industrial apparatus, or a portion thereof, such as a machine or a system or one or more containers for producing food or drinks.

It has been surprisingly found that the application of the composition (C) according to the invention allows marks, dirt and residues of various kinds to be removed efficiently and quickly. In practice, the substrate to be treated is freed almost instantaneously from the contaminants, which are transferred, as a suspension and/or solution, into the aqueous composition. The speed of the treatment is particularly advantageous for applications in the industrial field as it allows cleaning operations to be made quicker and downtime of the system to be decontaminated to be minimized.

As non-limiting embodiments of the present invention, the composition (C) can be used for the cleaning or decontamination of plumbing fixtures, sinks, hobs, glasses and glassware, crockery, cutlery and floors, as a degreaser, paint remover, e.g. for removing synthetic based paints such as acrylic paints from a metal or masonry or mixed material substrate, such as an oxide cleaner, stain remover or for other similar uses.

The method according to the present invention can comprise the separation of the aqueous mixture containing the components of (C) and the residues of the contaminant from said substrate though any one of the methods known to a person skilled in the art.

An embodiment of the present invention is a cleaning composition in liquid form comprising at least water and:

i. at least one selected from citric acid, oxalic acid, tartaric acid, malic acid and the respective sodium or potassium salts and mixtures thereof in amounts from 0.4 to 45%, preferably from 5 to 20%, more preferably from 11 to 18% by weight with respect to the total volume of the composition;

ii. at least one solvent selected from methanol, ethanol, ethyl acetate, propanol and isomers thereof, preferably ethylene glycol, butanol and isomers thereof, water-soluble esters, preferably methyl acetate, ethyl acetate, ethyl formate, dimethyl carbonate, esters of carbonic acid and mixtures thereof, in an amount from 1.5 to 20%, preferably from 3.5 to 18%, more preferably from 4 to 15% by weight with respect to the total volume of the composition, and

iii. at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin, and relative mixtures from 0.1 to 7%, preferably from 1.5 to 6%, more preferably from 2 to 5% by weight with respect to the total volume of the composition.

In a preferred embodiment of the present invention, in said cleaning composition, the acid i. is citric acid and/or the solvent ii. is ethyl acetate or ethanol, and/or the surfactant iii. is coco-glucoside, preferably wherein the acid i. is citric acid, the solvent ii. is ethyl acetate or ethanol and the surfactant iii. is coco-glucoside.

Within the context of the present invention, the citric acid can be, indifferently, in anhydrous or hydrated form, e.g. citric acid monohydrate. The amounts relate to anhydrous citric acid; unless otherwise indicated, in the case of using hydrated citric acid, the amounts will consequently be adapted, so as to compensate for differences in molecular mass.

In a preferred embodiment of the present invention, in said cleaning composition the acid i. is in amounts from 1.5 to 20%, the solvent ii. is in amounts from 0.1 to 7% and the surfactant iii. is from 0.1 to 7% by weight with respect to the total volume of the composition.

In a preferred embodiment, in the method of the present invention the solvent ii. is ethanol, or a mixture of C₁-C₄ alcohols as defined above comprising at least ethanol. In a preferred embodiment, alcohol or aliphatic alcohol preferably means ethanol. In a preferred embodiment, ester preferably means ethyl acetate, methyl acetate, ethyl formate, dimethyl carbonate and mixtures thereof, more preferably ethyl acetate, demethyl carbonate and mixtures thereof.

Water soluble low molecular weight ester means an ester with molecular weight no greater than 200 with water solubility such for which a part of solvent forms a clear and one-phase solution with 30 parts of water or less.

The composition according to the present invention can comprise further components in addition to the acid i., the solvent ii. and the surfactant iii.

As non-limiting examples, said components can include co-formulants and/or additives such as salts, other surfactants, emulsifiers, preservatives, natural extracts, aromas and mixtures thereof.

In a preferred embodiment, the composition according to the present invention can further comprise at least one from between ethylenediaminetetraacetic acid (EDTA) preferably in the form of bisodium salt, sodium chloride, oxygenated water, sodium perborate, sodium percarbonate, acetic acid (also in the form of vinegar), orthophosphoric acid, xanthan gum, a carbonate and/or bicarbonate of an alkali metal. The composition according to the present invention is characterized by a good foaming effect, moderate wetting power, excellent cleaning and emulsifying power and good dissolving power.

The composition according to the present invention can be used, in general, in the cleaning/decontamination treatment of various surfaces. In fact, it can be used as a cleaning composition for washing dishes, for dishwashers also with a rinse aid effect, for washing glasses, for cleaning plumbing fixtures, sinks, floors, tiles, for tea and coffee pots, as a detergent for the maintenance of dishwashers and washing machines and as an anti-mould detergent for walls. The cleaning/decontaminating composition according to the present invention can also be used as a cleaning liquid in the washing machine, for hand washing, also having a softener effect and/or as a stain remover with oxidizing power.

In some of these applications specific additives may be envisaged such as excipients or stain removing additives which will be described in more detail below in the present application, but the essential advantage of the cleaning composition according to the present invention is that of being 100% biological (i.e. all the components are of natural origin and can be obtained from plants/fruit), and being 100% biodegradable in a maximum of two years. Therefore, the cleaning (or decontaminating) composition according to the present invention has replaced the surfactants of compositions according to the state of the art with substances that are, surprisingly, capable of acting as detergents or washing solutions/decontaminants, also when present in a reduced amount of a third/quarter with respect to the amount of surfactants according to the state of the art, guaranteeing washing/decontamination quality and performance greater than or equal to the products of the state of the art and the products present on the market and based on standard surfactants.

In a preferred embodiment, the composition according to the present invention comprises at least one emulsifier from between soy lecithin, soy lysolecithin and mixtures thereof and, furthermore, limonene, citral or another similar terpene and mixtures thereof. In a preferred embodiment, in the composition according to the present invention limonene, or a terpene analog, where present, is contained in an amount from 0.1 to 7.5%, more preferably from 0.3 to 5%, even more preferably from 0.5 to 2.5% by weight with respect to the total volume of the composition. Possible anti-stain additives are as follows:

in the case of a composition to be used as a detergent for dishes or for cleaning hard surfaces, or as a detergent for the washing machine, sodium chloride may also be present in a concentration that can vary from 15 to 25% by weight with respect to the weight of the cleaning composition. Sodium chloride is particularly effective in the cleaning composition according to the present invention, especially when vinegar is also present, as a further additive (in turn containing 6% acetic acid) in an amount that varies from 3 to 6% by weight, preferably equal to 5% by weight with reference to vinegar. The use of said composition is particularly advantageous for removing incrustations from saucepans, frying pans, pans, ovens and hobs, caused by the leakage of foods and remains of burnt food, in removing wine stains, pigments and mud from fabrics, in removing rust marks and in polishing metals eliminating oxidation or opaque calcareous or dirty patina. It also facilitates the removal of odours (e.g. from wooden chopping boards).

In a preferred embodiment, vinegar (containing 6% acetic acid) is present in an amount that varies from 3 to 6% by weight, also in the absence of sodium chloride, as a particularly effective anti-stain additive in removing crusty, cooked, complex and odorous fat stains, bad smells, coffee and tea encrustations, pigment marks such as wine, in removing residual sticky residues of labels and in polishing chrome plating.

A preferred composition for such uses comprises:

citric acid 20% by weight

vinegar (6% acetic acid) 5% by weight

sodium chloride 20% by weight

ethanol 5% by weight

water up to 100% by weight

Possible excipients are xanthan gum as a gellant in the case of cleaning compositions to be used as detergents for dishwashers, hand washing and washing machines; zeolite and sodium percarbonate as a two-component additive in the case of cleaning compositions to be used as stain-removing products for household use.

Compositions (approximative) that represent preferred, but not limiting, embodiments, of the present invention are reported below (by weight of components for a litre of composition):
for use as a detergent for plumbing fixtures, sinks and hobs:

Water: 850 g/L; ethyl alcohol 18 g/L, citric acid monohydrate 180 g/L, coco-glucoside 18 g/L;
for use as a glass cleaner Water 850 g, denatured ethyl alcohol (90% v/v) 150 mL/L, citric acid monohydrate 5 g/L, coco-glucoside 1 g/L;
for use to remove stains in laundry with oxidising power:

Water 800 g, ethyl acetate 35 mL/L, citric acid monohydrate 180 g/L or alternatively sodium citrate in equal amounts or a mixture of the last two elements or alternatively tartaric acid or sodium tartrate in equal amounts, coco-glucoside 25 g/L, oxygenated water 30% (100 vol) from 50 mL/L to 200 mL/L, vinegar (6% acetic acid) 50 mL/L, sodium chloride 130 g/L
for use as a detergent for dishes and crockery:

Water 800 g, ethyl acetate 35 mL/L, citric acid monohydrate 110 g/L, coco-glucoside 66 g/L, glyceryl oleate 22 g/L, vinegar (6% acetic acid) 45 mL/L, sodium chloride 190 g/L, xanthan gum 5 g/L;
for use as a detergent for dishwashers:

Water 850 g, ethyl acetate 15 mL/L, sodium carbonate 100 g/L, sodium acetate 3 g/L, trisodium citrate 55 g/L, alkyl polyglucoside 20 g/L, sodium chloride 50 g/L, xanthan gum 3 g/L;
for use as a degreaser or universal paint stripper:

Water 850 g, ethyl alcohol (90% v/v) or ethyl acetate 40 mL/L or, alternatively, a mixture of ethyl alcohol and/or ethyl acetate and/or methyl acetate with dimethyl carbonate from 5 to 20 mL/L, citric acid monohydrate 200 g/L, coco-glucoside 60 g/L, vinegar (6% acetic acid) 100 mL/L, limonene, citral or a mixture thereof from 5 mL/L to 25 mL/L, lecithin 3 g/L.
for use as a rinse aid:

Water 770 g, ethyl acetate 15 mL/L, citric acid monohydrate 346 g/L, lecithin 1 g/L.
for use as a detergent for hand washing laundry:

Water 890 g, sodium bicarbonate 80 g/L, sodium carbonate 70 g/L, trisodium citrate 40 g/L, ethyl acetate 15 g/L, alkyl polyglucoside 18 g/L, xanthan gum 2 g/L
for use as a detergent for washing machines:

Water 890 g, sodium bicarbonate 80 g/L, sodium carbonate 70 g/L, trisodium citrate 40 g/L, ethyl acetate 15 g/L, alkyl polyglucoside 18 g/L, xanthan gum 3 g/L

The following examples are provided to illustrate some embodiments of the invention, without limiting the object thereof.

### EXAMPLE 1

An amount of 1-1.5 litres of cleaning composition according to the present invention consisting of citric acid at the concentration of 20% by weight/total weight of the concentration, with ethyl alcohol added at 4% by weight/total weight of the concentration, and a surfactant at 6% was tested on a machine for foodstuffs of about 8-10 m³ of volume, contaminated by calcium based deposits, animal fats, sugars, cereals both of a dairy and of a poultry farming plant.

Through a cleaning treatment by spraying the solution, rinsing and finally drying with a dry cloth, such composition allowed the removal of all the limescale, the biological and carbonaceous elements accumulated, the oxides formed during the operation of said machine at the aforesaid dairy and poultry farming plant, bringing the machine back to a “brilliant” polished state.

### EXAMPLE 2

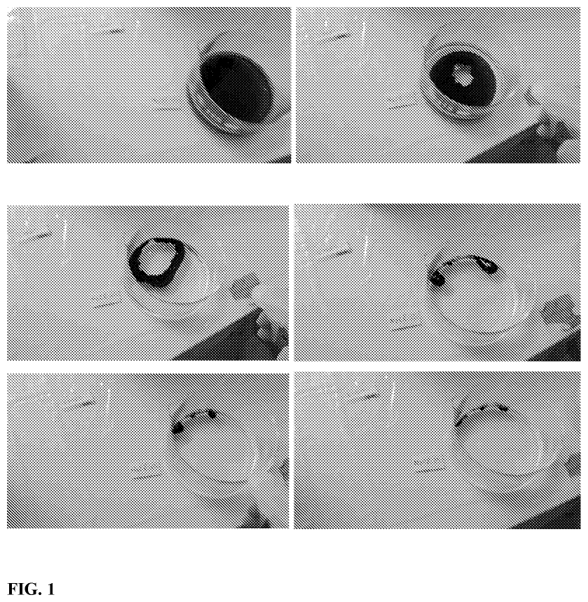

On a two-phase system comprising salty sea water (700 g, lower phase) and crude oil (about 3 g, upper phase) in an aluminium container, an aqueous composition containing citric acid (about 200 g/L), ethyl alcohol (about 40 g/L) and coco-glucoside (about 60 g/L), as well as limonene and other additives, was sprayed through a common manually operated sprayer. After 2/3 sprays the whole organic (black) phase was removed and the aqueous phase below is clear (treatment sequence shown in FIG. 1).

1. A method for cleaning a substrate from a contaminant in the industrial or in the household field, wherein said method comprises at least applying to the part of said substrate to be cleaned an aqueous composition (C) comprising:
i. at least one organic acid selected from citric acid, oxalic acid, tartaric acid, malic acid and the respective sodium or potassium salts and mixtures thereof;
ii. at least one solvent selected from methanol, ethanol, propanol and isomers thereof, propylene glycol, butanol and isomers thereof, a water soluble low molecular weight ester, methyl acetate, ethyl acetate, ethyl formate, dimethyl carbonate, esters of carbonic acid, and mixtures thereof; and
iii. at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin, and mixtures thereof,
so as to obtain an aqueous mixture comprising the components of the aqueous composition (C) and the residues of the contaminant.

2. The method according to claim 1, wherein the aqueous composition (C) comprises the organic acid i. in an amount from 0.4 to 45% by weight with respect to the total volume of the aqueous composition (C).

3. The method according to claim 1, wherein the aqueous composition (C) comprises the solvent ii. in an amount from 1.5 to 20% by weight with respect to the total volume of the aqueous composition (C).

4. The method according to claim 1, wherein the aqueous composition (C) comprises the surfactant iii. in an amount from 0.1 to 7% by weight with respect to the total volume of the aqueous composition (C).

5. The method according to claim 1, wherein the acid i. is citric acid or the solvent ii. is ethyl acetate, ethanol, methyl acetate, methyl formate, dimethyl carbonate or mixtures thereof or the surfactant iii. is coco-glucoside, wherein the acid i. is citric acid, the solvent ii. is ethanol or ethyl acetate, dimethyl carbonate or mixtures thereof and the surfactant iii. is coco-glucoside.

6. The method according to claim 1, wherein the aqueous composition (C) further comprises an emulsifying agent from soy lecithin, soy lysolecithin, and mixtures thereof and, also limonene, citral or another similar terpene or mixtures thereof.

7. The method according to claim 6, wherein in the aqueous composition (C) limonene, citral or another terpene analog thereof, or mixture thereof, is present in an amount from 0.1 to 7.5% by weight with respect to the total volume of the aqueous composition (C).

8. The method according to claim 1, comprising the step of cleaning household objects, furniture, houses, clothes, cutlery, tableware and/or kitchenware using the aqueous composition (C).

9. A cleaning composition (C) in liquid form comprising at least water and:
i. at least one selected from citric acid, oxalic acid, tartaric acid, malic acid and the respective sodium or potassium salts thereof, and mixtures thereof, in an amount from 0.4 to 45% by weight with respect to the total volume of the composition,
ii. at least one solvent selected from methanol, ethanol, propanol and isomers thereof, propylene glycol, butanol and isomers thereof, a water soluble low molecular weight ester, methyl acetate, ethyl acetate, ethyl formate, dimethyl carbonate, esters of carbonic acid, and mixtures thereof, in an amount from 1.5 to 20% by weight of the total volume of the composition, and
iii. at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin, and mixtures thereof in an amount from 0.1 to 7% by weight of the total volume of the composition.

10. The cleaning composition according to claim 9, wherein the acid i. is citric acid or the solvent ii. is ethyl acetate or ethanol or dimethyl carbonate or mixtures thereof or the surfactant iii. is coco-glucoside, wherein the acid i. is citric acid, the solvent ii. is ethyl acetate or ethanol and the surfactant iii. is coco-glucoside.

11. The cleaning composition according to any one of claim 9, which comprises an emulsifying agent selected from soy lecithin, soy lysolecithin, and mixtures thereof and, also, limonene or another similar terpene.

12. The composition according to claim 11, wherein limonene, or another terpene analog is present in an amount from 0.1 to 7.5% by weight with respect to the total volume of the composition.
